(19) United States
(12) Patent Application Publication
(10) Pub. No.: US 2025/0124498 A1
(43) Pub. Date: Apr. 17, 2025

(54) Generating Sponsored Content Pages Using Large Language Machine-Learned Models

(71) Applicant: Maplebear Inc., San Francisco, CA (US)

(72) Inventors: Prithvishankar Srinivasan, Seattle, WA (US); Shishir Kumar Prasad, San Ramon, CA (US); Min Xie, Santa Clara, CA (US); Shrikar Archak, Danville, CA (US); Shih-Ting Lin, Santa Clara, CA (US); Haixun Wang, Bellevue, WA (US)

(21) Appl. No.: 18/917,136

(22) Filed: Oct. 16, 2024

Related U.S. Application Data
(60) Provisional application No. 63/590,749, filed on Oct. 16, 2023.

(51) Int. Cl. G06Q 30/08; G06Q 30/0601

(52) U.S. Cl. CPC G06Q 30/08; G06Q 30/0631

(57) ABSTRACT

An online system presents a sponsored content page to a user in conjunction with a model serving system. The online system accesses a content page for a food item and identifies one or more sponsorship opportunities at the content page. The online system identifies one or more candidate sponsors for each sponsorship opportunity. The online system selects a bidding sponsor for the sponsorship opportunity from the one or more candidate sponsors and a candidate item associated with the bidding sponsor as a sponsored item. The online system provides a content page, a description of the sponsored item, and a request to generate a sponsored content page for the sponsorship opportunity to a model serving system. The online system receives a sponsored content page generated by a machine-learning language model at the model serving system and presents the sponsored content page to a user.

### CROSS-REFERENCE TO RELATED APPLICATIONS

This application claims priority under 35 U.S.C. § 119 (e) to U.S. Provisional Patent Application Ser. No. 63/590,749, filed on Oct. 16, 2023 which is incorporated by reference in its entirety.

### BACKGROUND

An online system is an online platform that connects users and retailers. A user can place an order for purchasing items, such as groceries, from participating retailers via the online system, with the shopping being done by a personal shopper. After the personal shopper finishes shopping, the order is delivered to the user's address. In some instances, the online system generates interfaces offering item recommendations or recommended combinations of items. These interfaces offer opportunities for third-parties to sponsor one or more of the recommended items, but the process of identifying which third-parties would be interested in sponsoring items displayed on the interface and generating the sponsored content pages may be time consuming. Further, generating content pages for the selected sponsors presents additional challenges that are not addressed by traditional systems. Such systems lack the technical capabilities to generate a sponsored content page within the short time frames required when a third-party is selected through an ad auction process. Furthermore, manually creating a sponsored content page for a single third-party is laborious and time-consuming.

### SUMMARY

In accordance with one or more aspects of the disclosure, an online system presents a sponsored content page to a user in conjunction with a model serving system. The online system accesses a content page for a food item. The content page comprises a title of the food item, instructions for preparing the food item, and a list of ingredients. The online system identifies one or more sponsorship opportunities at the content page. The online system uses a machine-learning model to identify one or more candidate sponsors for each sponsorship opportunity. The machine-learning model is trained to identify one or more candidate items for an ingredient related to the sponsorship opportunity. The online system selects a bidding sponsor for the sponsorship opportunity and selects a candidate item associated with the bidding sponsor as a sponsored item. The online system receives, for the sponsorship opportunity, a highest bidding sponsor of the one or more candidate sponsors.

The online system provides the content page, a description of the sponsored item, and a request to generate a sponsored content page for the sponsorship opportunity to a model serving system hosting a machine-learning language model. The online system receives a sponsored content page generated by the machine-learning language model that incorporates the sponsored item. The online system presents the sponsored content page to a user.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates an example content page, in accordance with some embodiments.

FIG. 3B illustrates a sponsored content page, in accordance with some embodiments.

FIG. 4 is a flowchart for a method of selecting a sponsor for the sponsored content page of a recipe, in accordance with some embodiments.

FIG. 5 is a flowchart for a method of generating a sponsored content page for a recipe, in accordance with some embodiments.

### DETAILED DESCRIPTION

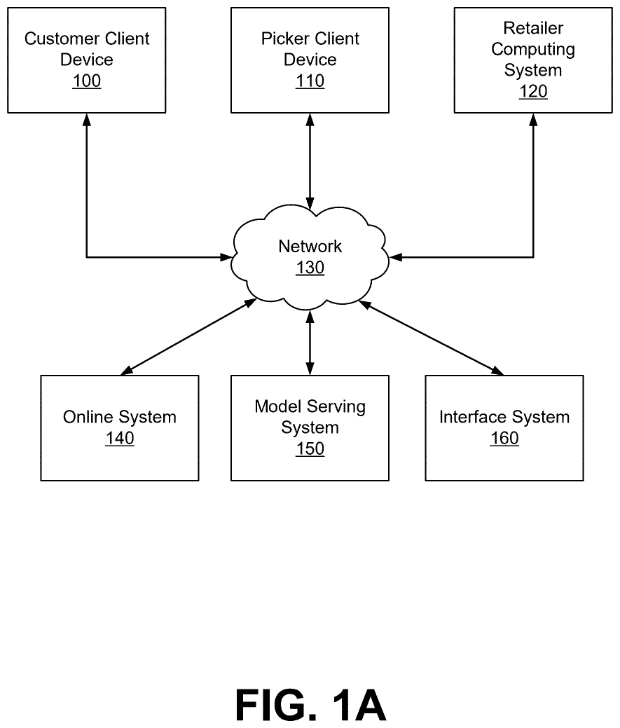

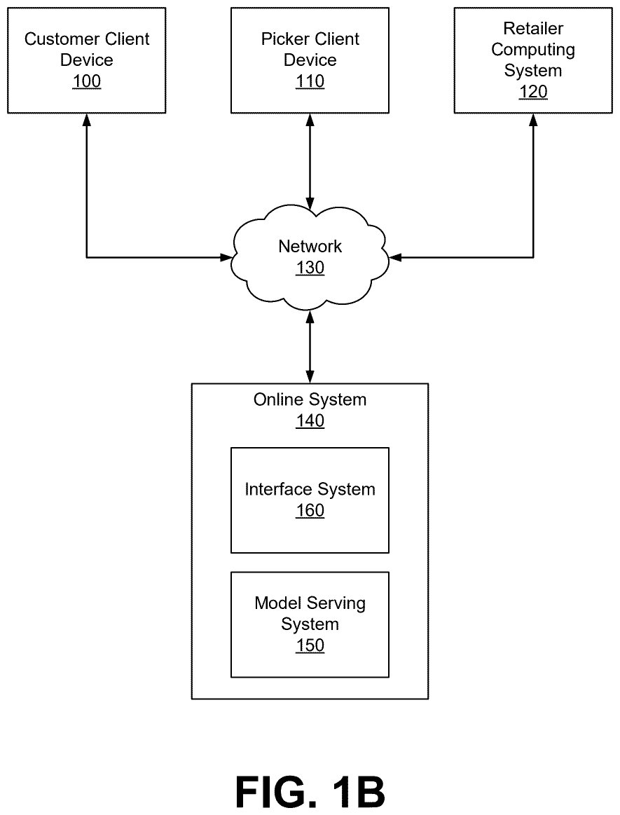

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In one or more embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

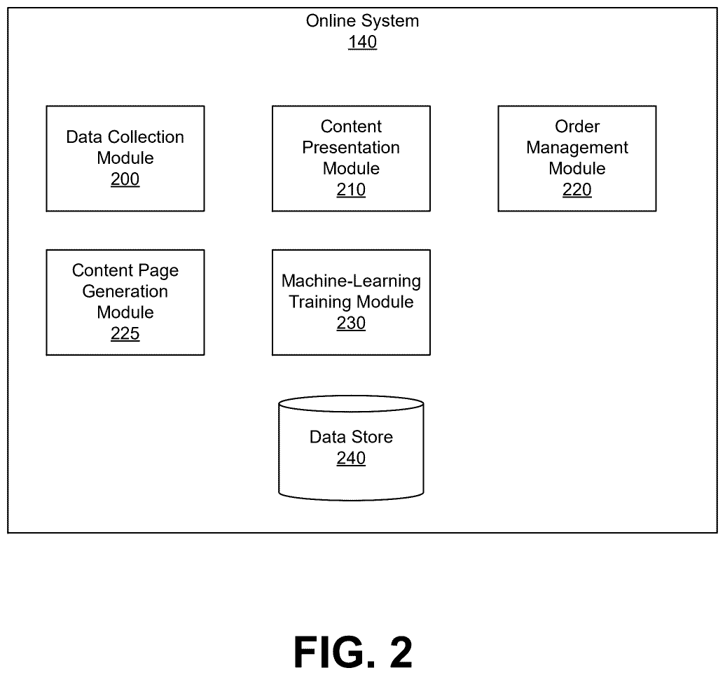

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the online system 140 generates a content page for incorporating a sponsored item. In this embodiment, the content page is a sponsored recipe page that is generated in conjunction with an LLM. Generating content pages while considering the specific attributes of the selected sponsors presents additional challenges that are not addressed by traditional systems. Such systems lack the technical capabilities to generate a sponsored content page within the short time frames required when a sponsored item is selected through an ad auction process. Further, it is quite laborious and time-consuming to manually create a sponsored content page for a sponsored item.

Specifically, the online system 140 described herein accesses a content page (e.g., recipe page) for an item, the content page comprising a title of a recipe, instructions for preparing the recipe, and/or a list of ingredients. As an example, the online system 140 accesses a content page for a Moscow Mule beverage including ginger beer as an ingredient. The content page includes a recipe with a title, a list of ingredients, and instructions for preparing the recipe. The online system 140 identifies one or more sponsorship opportunities for the accessed content page. The online system 140 may identify by a machine-learning model one or more candidate items for an ingredient related to sponsorship opportunities.

For each candidate item, the online system 140 identifies a bidding sponsor and the candidate items enter into an auction platform. The online system 140 selects a sponsorship opportunity associated with a candidate item for the content page. As an example, the selected sponsorship opportunity for a ginger beer may be a specific brand of ginger beer (e.g., Alpha Beta Gamma company). The online system 140 provides, to a model serving system 150 hosting a machine-learning language model, the content page, a description of the sponsored item, and/or a request to generate a sponsored content page for the sponsorship opportunity. The online system 140 receives from the model serving system 150, the generated sponsored content page that incorporates the sponsored item. The online system 140 presents the generated sponsored content page to the user.

By utilizing an LLM to generate a sponsored content page, the LLM naturally incorporates the sponsored content item into the content page within the short time frame. The LLM may be equipped to ensure that the selected sponsors' items are seamlessly integrated into the content in a way that feels organic and relevant.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a sponsorship management module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The content page generation module 225 identifies a sponsorship opportunity on a content page displayed to a user. As described herein, a “sponsorship opportunity” describes an opportunity for the online system 140 to present sponsored content related to an item or recommended combination of items (e.g., a recipe). As described herein, a “content page” is an instruction guideline or a recipe to create a specific item or to complete a task. As an example, a content page may be for a recipe for a food or beverage item. A content page may also include a list of steps to complete a task (e.g. changing a lightbulb), or a list of steps to create a crafty item (e.g., knitting a sweater). Specifically, the online system 140 may display various forms of sponsored content (e.g., advertisements, featured items responsive to search query) on the search page, website, or home page of the online system 140. However, the content for these sponsored content items are typically manually created and takes time to create each content. In one or more embodiments, the content page generation module 225 identifies sponsorship opportunities on new surfaces or content pages—in one or more instances, the content items to be sponsored are recipe pages. For example, a recipe page may include a title or name for a recipe, a list of ingredients for the recipe, instructions for making the recipe, and the like. The recipe page (or any type of content page) may be presented to a user responsive to a user search for a recipe (e.g., recipe for chicken salad).

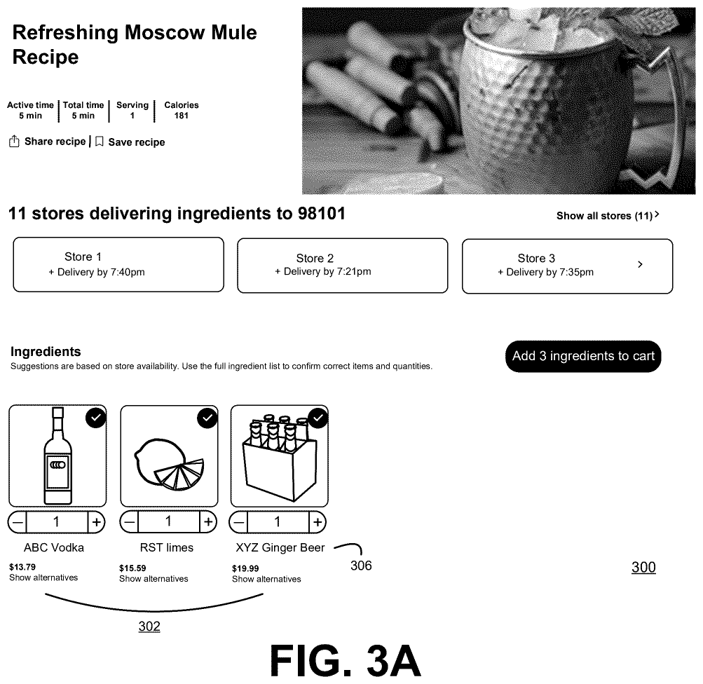

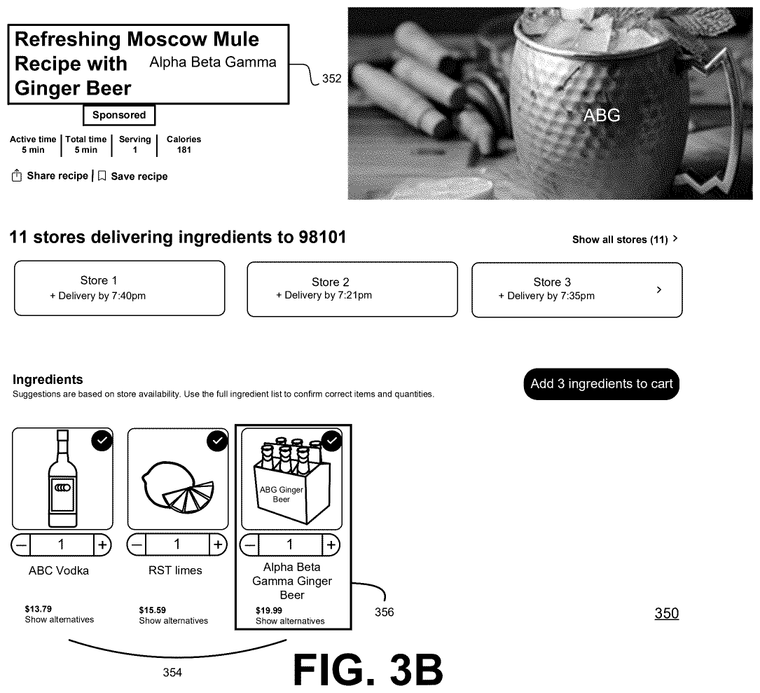

FIG. 3A illustrates an example content page, in accordance with some embodiments. In the illustrated embodiment, the content page (unsponsored) lists a title of the recipe “Refreshing Moscow Mule Recipe” and a list of general ingredients necessary to prepare the recipe. The content page 300 may provide a description of the Moscow Mule, a list of ingredients, and instructions for preparing the ingredient, for example as:
Refreshing Moscow Mule Recipe
About this recipe: Discover the ultimate summer sipper—the refreshing Moscow Mule. Made with vodka, lime juice, and effervescent ginger beer, this vibrant cocktail is served over ice in a copper mug.
Full ingredient list: 2 oz vodka ½ oz fresh lime juice Lime wedges, for garnish Ice 4 oz ginger beer
Instructions: 1 Fill a copper mug with ice. 2 Add vodka and lime juice, top with ginger beer. 3 Stir gently to combine. 4 Garnish with lime wedges.

In some embodiments, for each ingredient, the content page 300 may further suggest a recommended item for each general ingredient with an option for the user to purchase the recommended item for each ingredient. In the illustrated embodiment, the Moscow Mule recipe calls for three ingredients 302: vodka, lime wedges, and ginger beer. Accordingly, the content page displays a recommended item for each ingredient: ABC Vodka, RST limes, and XYZ Ginger Beer 306.

In some embodiments, the content page generation module 225 determines a recommended item for each ingredient by selecting the most popular variety of the item from a set of candidate items. As described herein, a “variety” of an item may refer to the packaging (e.g., a 4 pack or a 6 pack of a beverage) or a brand of an item (e.g., one third party's product versus another party's product). In one or more embodiments, the content page generation module 225 identifies the most popular variety as the variety most regularly selected by users. In another embodiment, the content page generation module 225 identifies the most popular variety as the highest rated variety of the item in the sponsorship management module 225.

In one or more embodiments, the content page generation module 225 may determine to generate a sponsored content page by identifying a sponsorship opportunity for one or more candidate items that, for example, map to one or more ingredients of the recipe. Because each candidate item is sponsored by a third party, the content page generation module 225 identifies a content page displaying a combination of recommended items (e.g., the recipe page displayed in FIG. 3A) as a sponsorship opportunity. In some embodiments, the content page generation module 225 identifies a sponsorship opportunity on any content page where a variety of items are or may be displayed to a user, and any one or more of those items can be fulfilled by candidate items sponsored by a third-party.

Specifically, upon identifying a sponsorship opportunity at a content page, the content page generation module 225 may identify one or more candidate sponsors who may be interested in the sponsorship opportunity. In one or more embodiments, the content page generation module 225 identifies third parties associated with candidate items that can be mapped to ingredients within the recipe. For example, a machine-learned search model may receive a name of an ingredient in the recipe (e.g., ginger beer), and output a list of relevant items in the catalog of the online system 140 to the ingredient as candidate items, via for example, a search model.

In one or more embodiments, the content page generation module 225 identifies third parties associated with items that could be offered as substitutes to each recommended item displayed on the content page. The content page generation module 225 may identify candidate sponsors by implementing a machine-learning model, described herein as a replacement model, to identify substitute items for each recommended item displayed on the candidate page. In one or more embodiments, the replacement model identifies substitute items as items that could be offered as replacements for a recommended item if the recommended item was unavailable or only available in a limited quantity or the particular user cannot consume the ingredient. For example, if a user is allergic to ginger, the online system 140 may use the replacement model to identify one or more replacement items to ginger beer that go well with the Moscow Mule recipe.

Continuing from the Moscow Mule example illustrated in FIG. 3A, the content page generation module 225 may identify third parties associated with alternate brands of vodka and ginger beer as candidate sponsors. In some embodiments, the content page generation module 225 identifies all the identified third parties as candidate sponsors. In other embodiments, the content page generation module 225 identifies a subset of the identified third parties as candidate sponsors. For example, the content page generation module 225 may identify only third parties associated with items who have reached a threshold amount of sales or a threshold level of user satisfaction (e.g., user reviews).

The replacement model may be a machine-learning model trained to identify substitute goods based on a training dataset of historical user activity where each entry is labeled with an item a user intended to purchase and an alternate item the user purchased in place of the intended item. The training dataset may be dynamically updated as user data is periodically collected, and the replacement model may be periodically re-trained using the updated training dataset. In another embodiment, the replacement model may access a lookup table where different varieties of items are sorted by type. For example, the lookup table may include an entry for “vodka” and a list of varieties of vodka (e.g., different brands and different packages of vodka).

In some embodiments, the content page generation module 225 transmits a list of replacement items to the model serving system 150, where an LLM ranks the replacement items identified by the content page generation module 225 based on one or more factors such as relevance, quality, popularity, and availability. The content page generation module 225 identifies candidate sponsors based on the rankings generated by the LLM.

In one or more embodiments, the content page generation module 225 uses an LLM to identify candidate items for an ingredient. For example, the content page generation module 225 may request an LLM to identify potential substitute ingredients to ginger beer, and map the substitute ingredients to items in the product catalog of the online system 140. The set of identified items is considered as candidate items for the sponsorship opportunity.

In some embodiments, the content page generation module 225 treats an entire content page as a singular sponsorship opportunity. In such embodiments, the content page generation module 225 may invite candidate sponsors identified for each item of the ingredients to the auction event. Continuing from the Moscow Mule content page 300 illustrated in FIG. 3A, the content page generation module 225 may invite candidate sponsors identified for vodka, ginger beer, and limes. In one or more other embodiments, the content page generation module 225 treats each item of the ingredient list as a sponsorship opportunity and hosts different auction events for each sponsorship opportunity. In such embodiments, the content page generation module 225 may invite candidate sponsors identified for each item to the respective auction event. Continuing from the Moscow Mule content page 400 illustrated in FIG. 3A, the content page generation module 225 may invite candidate sponsors identified for vodka to an auction event for the vodka ingredient.

The content page generation module 225 transmits the sponsorship opportunity to an auction platform (not shown) with a list of candidate sponsors identified for the sponsorship opportunity. The auction platform invites each candidate sponsor to an auction event to bid on the sponsorship opportunity and conducts an auction event for the sponsorship opportunity. At the auction event, each candidate sponsor places a bid for the sponsorship opportunity and the auction platform offers the sponsorship opportunity to the candidate sponsor with the highest bid. For each sponsorship opportunity on a content page, the content page generation module 225 receives the candidate sponsor with the highest bid. The content page generation module 225 transmits the content page and the highest bidding sponsor to the model serving system 150 to generate a sponsored content page 350. In embodiments where the LLM generates a ranked list of the candidate items, the content page generation module 225 may select a sponsor for the sponsorship opportunity as a function of their bid placed at the auction event and the ranking of items associated with the sponsor.

In one or more embodiments where the LLM generates a ranked list of the candidate items, the content page generation module 225 may select a sponsor for the sponsorship opportunity as a function of their bid placed at the auction event and the ranking of items associated with the sponsor.

In one or more embodiments, the content page generation module 225 implements the LLM to generate a sponsored content page. The LLM generates a sponsored content page that replaces instances of the general ingredient with the highest bidding third-party. FIG. 3B illustrates a sponsored content page 350, in accordance with some embodiments. In the illustrated embodiment, the highest bidding sponsor was Alpha Beta Gamma, a retailer of ginger beer. Accordingly, the LLM generates a sponsored content page 350 from the content page illustrated in FIG. 3A. In the illustrated content page, the LLM updates the title of the recipe to include the name of the highest bidding sponsor “Alpha Beta Gamma” 352. Accordingly, the LLM updates the title from “Refreshing Moscow Mule Recipe” to “Refreshing Moscow Mule Recipe with Alpha Beta Gamma Ginger Beer” 352. Additionally, whereas the initial content page illustrated in FIG. 3A presented “XYZ Ginger Beer” 306 as the recommended item for the ginger beer general ingredient. However, because Alpha Beta Gamma was the highest bidding sponsor and is associated with their own ginger beer, the LLM generates a sponsored content page where the recommended item for ginger beer is “Alpha Beta Gamma” Ginger Beer 356. As described herein, the product related to the recipe and associated with the highest bidding sponsor is referred to as a “sponsored item.”

In embodiments where the content page generation module 225 implements the LLM to generate a sponsored content page, the content page generation module 225 prompts the LLM to generate a sponsored content page associated with a received recipe and the corresponding item sponsor. As an example, a prompt to the LLM may be “For the given recipe, make a variation of this recipe by making it sponsored content. Alpha Beta Gamma is sponsoring this recipe by substituting the ginger beer with XYZ ginger beer.”

In one or more embodiments, the content page generation module 225 may also prompt a multi-modal LLM to generate or overlay a cover image of the received recipe with an image of the sponsored item. The cover image of the received recipe may include a sponsored image generated by the LLM or an overlayed image that includes the sponsorship. As an example, a prompt to the LLM may be “For the given recipe, generate an image of a ginger beer that is sponsored by Alpha Beta Gamma.”

In embodiments where the content page generation module 225 recognizes multiple sponsorship opportunities at a single content page (e.g., sponsorship opportunities for each general ingredient), the LLM may similarly update each recommended item to reflect a sponsored item corresponding to the general ingredient. In some embodiments, the LLM may also generate an updated graphic that displays the sponsored item in a graphic adjacent to the title. The updated graphic may be an image of the sponsored item from the selected ad candidate company.

In some embodiments, the LLM may further update other instances of a general ingredient displayed on the content page with the sponsored content page. As described above, a content page may also contain a description of the recipe, a list of general ingredients, and instructions for preparing the recipe. For example, the content page illustrated in FIG. 3A may further display:
Refreshing Moscow Mule Recipe
About this recipe: Discover the ultimate summer sipper—the refreshing Moscow Mule. Made with vodka, lime juice, and effervescent ginger beer, this vibrant cocktail is served over ice in a copper mug.
Full ingredient list: 2 oz vodka ½ oz fresh lime juice Lime wedges, for garnish Ice 4 oz ginger beer
Instructions: 1 Fill a copper mug with ice. 2 Add vodka and lime juice, top with ginger beer. 3 Stir gently to combine. 4 Garnish with lime wedges.

Accordingly, the LLM may generate a sponsored content page illustrated in FIG. 3B by replacing all instances of “ginger beer” with the sponsored item “Alpha Beta Gamma ginger beer” 356. For example, the sponsored content page illustrated in FIG. 3B may further display:
Refreshing Moscow Mule Recipe with Alpha Beta Gamma ginger beer
About this recipe: Discover the ultimate summer sipper—the refreshing Moscow Mule. Made with vodka, lime juice, and effervescent Alpha Beta Gamma ginger beer, this vibrant cocktail is served over ice in a copper mug.
Full ingredient list: 2 oz vodka ½ oz fresh lime juice Lime wedges, for garnish Ice 4 oz Alpha Beta Gamma ginger beer
Instructions: 1 Fill a copper mug with ice. 2 Add vodka and lime juice, top with Alpha Beta Gamma ginger beer. 3 Stir gently to combine. 4 Garnish with lime wedges.

In some embodiments, the content page generation module 225 may transmit tuning instructions to the LLM to only replace certain instances of the generic ingredient with the sponsored item, for example the title of the recipe, the instructions for preparing the recipe, and the recommended item displayed with the list of ingredients.

The content page generation module 225 provides instructions for generating the sponsored content page to a client device of a user to cause presentation of the sponsored content page. The content page generation module 225 may also map the list of ingredients for the recipe to one or more items in an item catalog including the sponsored item. The mapped items are also presented to the user for purchase or for adding to the user's order. The content page generation module 225 may also obtain feedback data to determine whether the user purchased the sponsored item in conjunction with the sponsored content page. In one or more embodiments, if the user purchased the sponsored item, the content page generation module 225 generates training data based on the contents of the sponsored content page and the original request to the LLM to generate the sponsored content page. The training data may be used to fine-tune parameters of the LLM.

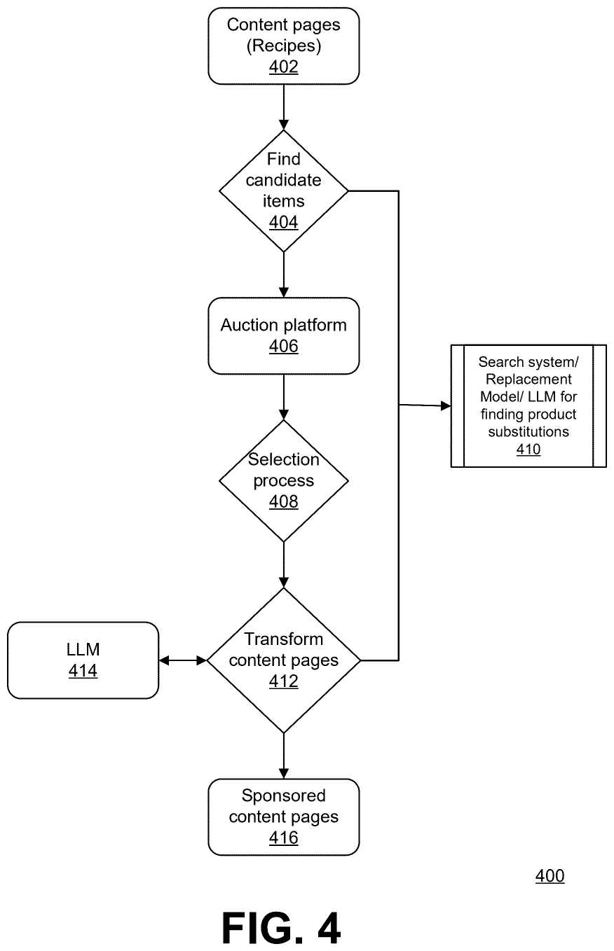

In FIG. 4, a flowchart describing how a sponsor is selected by the sponsorship management module 225, in accordance with one or more embodiments. The content page generation module 225 obtains a content page 402, or a recipe page. The content page 402 includes a set of ingredients or items. As an example, the content page 402 may include a set of ingredients for a Moscow Mule such as ginger beer, limes, and vodka. The content page generation module 225 finds one or more candidate items 404 for the items or ingredients associated with the content pages 402. As an example, the content page generation module 225 may find the corresponding candidate items for the ginger beer ingredient: Alpha Beta Gamma, Alpha Beta Phi, and Alpha Beta Theta ginger beer. A search system, a replacement model, or a LLM may be prompted 410 to find product substitutions for the ingredients associated with the content page 402 that are mapped to candidate items in a product catalog of the online system 140. As another example, a substitution for the ingredients for a Moscow Mule may be lime instead of lemon. The auction platform 406 includes a platform for the sponsors of the candidate items to participate in a selection process (e.g., bidding process) 408. In one or more embodiments, the bidding process 408 is automated to select a candidate item with the highest bid during the ad bidding process 408. The content page generation module 225 transforms 412 the content page to include the sponsored item. In one or more embodiments, the LLM 414 may be prompted to generate the content of the page to include the sponsored item for the selected candidate.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

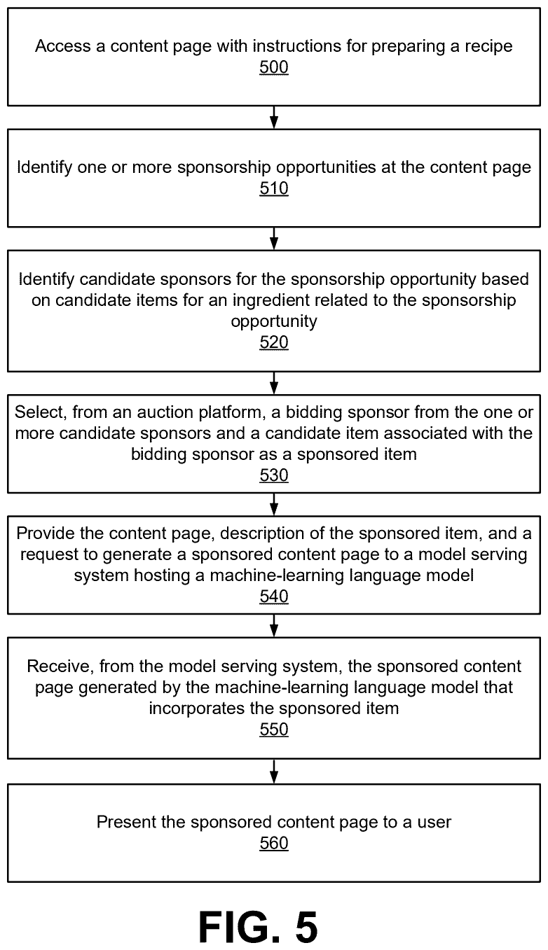

FIG. 5 is a flowchart for a method of generating a sponsored content page for a recipe, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system 140 accesses 500 a content page with instructions for preparing a recipe. The content page includes a title of the recipe, a list of general ingredients, and instructions for preparing the recipe. The content page may also display a recommended item for each general ingredient. The online system 140 identifies 510 one or more sponsorship opportunities at the content page. In some embodiments, the online system 140 treats the content page as a singular sponsorship opportunity. In other embodiments, the online system 140 treats each general ingredient as a sponsorship opportunity. The online system 140 identifies 510 candidate sponsors for each sponsorship opportunity based on candidate items for an ingredient related to the sponsorship opportunity. For each recommended item, the online system 140 applies a replacement model to identify a set of substitute goods for the recommended item. The online system 140 identifies 520 a third-party associated with each substitute good as a candidate sponsor who may be interested in bidding on the sponsorship opportunity. The online system 140 transmits the list of candidate sponsors to an auction platform, where an auction is held for the sponsorship opportunity.

The online system selects 530 a bidding sponsor from the one or more candidate sponsors through an auction platform and selects a candidate item associated with the bidding sponsor as a sponsored item. The online system 140 provides 540 the content page, description of the sponsored item, and a request to generate a sponsored content page to a model serving system hosting a machine-learning language model. The online system 140 receives 550 a sponsored content page that incorporates the sponsored item generated by the machine-learning language model from the model serving system 150. The sponsored content page replaces instances of the general ingredient with a sponsored product associated with the highest bidding sponsor, for example in the title and the instructions. Additionally, the sponsored content page updates the recommended item to reflect the sponsored product. The online system 140 transmits instructions for presenting 560 the sponsored content page to a client device of a user. In one or more embodiments, the online system 140 also collects feedback from the user on the sponsored content page, and uses the feedback to further fine-tune the LLM of the model serving system 150. For example, the feedback may indicate that a user converted a sponsored content page with one or more sponsored items by purchasing the sponsored items. The prompt and output generated by the LLM for the sponsored content page may be used as a training instance to fine tune the parameters of the LLM.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
accessing a content page for a recipe, wherein the content page includes a title of the recipe, instructions for preparing the recipe, and a list of ingredients;
identifying one or more sponsorship opportunities at the content page;
identifying, by a machine-learning model, one or more candidate sponsors for each sponsorship opportunity, wherein the machine-learning model is trained using a dataset of items related to a query to identify one or more candidate items for an ingredient related to the sponsorship opportunity;
selecting, for the sponsorship opportunity, a bidding sponsor of the one or more candidate sponsors and a candidate item associated with the bidding sponsor as a sponsored item;
providing, to a model serving system hosting a machine-learning language model, the content page, a description of the sponsored item, and a request to generate content for a sponsored content page for the sponsorship opportunity;
generating instructions for presenting the sponsored content page based on a response received from the machine-learning language model, wherein the sponsored content page incorporates the sponsored item; and
transmitting the instructions to a client device to cause presentation of the sponsored content page to a user.

2. The method of claim 1, wherein the presented sponsored content page includes a modified title incorporating the sponsored item and an indication that one or more sponsored items are included.

3. The method of claim 1, wherein the presented sponsored content page includes modified instructions indicating how to use the sponsored item in the recipe.

4. The method of claim 1, further comprising:
providing, to a multi-modal model, at least a request to generate an image describing the recipe that incorporates the sponsored item; and
receiving a second response including the generated image, wherein the generated sponsored content page includes the generated image.

5. The method of claim 1, wherein the one or more candidate items for the ingredient related to the sponsorship opportunity represent a set of replacement items to replace the ingredient in the recipe.

6. The method of claim 5, wherein identifying the one or more candidate sponsors further comprises:
obtaining a set of candidate items by the machine-learning model and corresponding replacement scores, wherein a replacement score for a respective candidate item is generated by applying the machine-learning model indicates whether the respective candidate item is a good replacement for the ingredient;
ranking the set of candidate items according to the replacement scores; and
selecting a subset of the set of candidate items as the one or more candidate items for the sponsorship opportunity.

7. The method of claim 1, wherein in the dataset of the items and the query for training the machine-learning model, the query is a particular item and the items are a set of replacement items for the particular item.

8. The method of claim 1, wherein selecting the bidding sponsor further comprises:
performing an auction process among the one or more candidate sponsors to obtain bids for the sponsorship opportunity associated with the content page, wherein the selected bidding sponsor is associated with a respective bid above a threshold bid or proportion among the bids obtained for the sponsorship opportunity.

9. The method of claim 1, further comprising:
mapping the list of ingredients to one or more items in an item catalog, and wherein transmitting the instructions further comprises transmitting instructions to cause presentation of the one or more items including the sponsored item to the user for purchase.

10. The method of claim 1, further comprising:
obtaining feedback data to determine whether the user purchased the sponsored item after the presentation of the sponsored content page; and
responsive to the determination that the user purchased the sponsored item, fine-tuning parameters of the machine-learning language model using the contents of the sponsored content page.

11. A non-transitory computer-readable storage medium storing computer instructions, the computer instructions, when executed by one or more processors, cause the one or more processors to:
access a content page for a recipe, wherein the content page includes a title of the recipe, instructions for preparing the recipe, and a list of ingredients;
identify one or more sponsorship opportunities at the content page;
identify, by a machine-learning model, one or more candidate sponsors for each sponsorship opportunity, wherein the machine-learning model is trained to identify one or more candidate items for an ingredient related to the sponsorship opportunity;
select, for the sponsorship opportunity, a bidding sponsor of the one or more candidate sponsors and a candidate item associated with the bidding sponsor as a sponsored item;
provide, to a model serving system hosting a machine-learning language model, the content page, a description of the sponsored item, and a request to generate content for a sponsored content page for the sponsorship opportunity;
generate instructions for presenting the sponsored content page based on a response received from the machine-learning language model, wherein the sponsored content page incorporates the sponsored item; and
transmit the instructions to a client device to cause presentation of the sponsored content page to a user.

12. The non-transitory computer-readable storage medium of claim 11, wherein the presented sponsored content page includes a modified title incorporating the sponsored item and an indication that one or more sponsored items are included.

13. The non-transitory computer-readable storage medium of claim 11, wherein the presented sponsored content page includes modified instructions incorporating how to use the sponsored item in the recipe.

14. The non-transitory computer-readable storage medium of claim 11, wherein the computer instructions, when executed by the one or more processors, cause the one or more processors to:
provide, to a multi-modal model, at least a request to generate an image describing the recipe that incorporates the sponsored item; and
receive a second response including the generated image, wherein the generated sponsored content page includes the generated image.

15. The non-transitory computer-readable storage medium of claim 11, wherein the one or more candidate items for the ingredient related to the sponsorship opportunity represents a set of replacement items to replace the ingredient in the recipe.

16. The non-transitory computer-readable storage medium of claim 15, wherein the computer instructions that cause the one or more processors to identify the one or more candidate sponsors further cause the one or more processors to:
obtain a set of candidate items by the machine-learning model and corresponding replacement scores, wherein a replacement score for a respective candidate item indicates whether the respective candidate item is a good replacement for the ingredient;
rank the set of candidate items according to the replacement scores; and
select a subset of the set of candidate items as the one or more candidate items for the sponsorship opportunity.

17. A computer system comprising:
a processor; and
a non-transitory computer readable storage medium storing instructions that, when executed by the processor, cause the processor to perform actions comprising:
accessing a content page for a recipe, wherein the content page includes a title of the recipe, instructions for preparing the recipe, and a list of ingredients;
identifying one or more sponsorship opportunities at the content page;
identifying, by a machine-learning model, one or more candidate sponsors for each sponsorship opportunity, wherein the machine-learning model is trained to identify one or more candidate items for an ingredient related to the sponsorship opportunity;
selecting, for the sponsorship opportunity, a bidding sponsor of the one or more candidate sponsors and a candidate item associated with the bidding sponsor as a sponsored item;
providing, to a model serving system hosting a machine-learning language model, the content page, a description of the sponsored item, and a request to generate content for a sponsored content page for the sponsorship opportunity;
generating instructions for presenting the sponsored content page based on a response received from the machine-learning language model, wherein the sponsored content page incorporates the sponsored item; and
transmitting the instructions to a client device to cause presentation of the sponsored content page to a user.

18. The computer system of claim 17, wherein the presented sponsored content page includes a modified title incorporating the sponsored item and an indication that one or more sponsored items are included.

19. The computer system of claim 17, wherein the presented sponsored content page includes modified instructions incorporating how to use the sponsored item in the recipe.

20. The computer system of claim 17, wherein the non-transitory computer readable storage medium storing instructions that, when executed by the processor, cause the processor to perform actions comprising:
providing, to a multi-modal model, at least a request to generate an image describing the recipe that incorporates the sponsored item; and
receiving a second response including the generated image, wherein the generated sponsored content page includes the generated image.
